(19) United States
(12) Patent Application Publication
(10) Pub. No.: US 2025/0193090 A1
(43) Pub. Date: Jun. 12, 2025

(54) QUALITY OF EXPERIENCE FOR TELECOMMUNICATIONS NETWORKS

(71) Applicant: eSpace Networks, Inc., Dover, DE (US)

(72) Inventors: Prateek Dahale, Maharashtra (IN); Shadrach Benny Retnamony, Pembroke Pines, FL (US); William Vaughan, Atlanta, GA (US)

(21) Appl. No.: 18/972,281

(22) Filed: Dec. 6, 2024

Related U.S. Application Data
(60) Provisional application No. 63/607,160, filed on Dec. 7, 2023.

(51) Int. Cl. H04L 41/16; H04W 24/02

(52) U.S. Cl. CPC H04L 41/16; H04W 24/02

(57) ABSTRACT

A method for training a machine learning model to generate a quality of experience (QOE) score that may include providing a machine learning module with a data set comprising QOE data, wherein the QOE data comprises a set of pairings or a communication timing statistic and an associated human user feedback QOE score for the communication timing statistic. The machine learning module may be trained on the QOE data to generate QOE scores for each of the pairings of communication timing statistics and human user feedback QOE scores to minimize error, where error may be the aggregated difference of generated QOE scores and the human user feedback QOE scores. Also, a method for calculating a QOE score from a communication timing statistic may include generating a QOE score considering a DNS component, a TCP component, a TLS component, a latency component, and a data rate component.

### FIELD OF THE INVENTION

Embodiments of the present invention generally relate to a system and method for measuring a Quality of Experience (“QOE” or “QoE”) for telecommunications networks, specifically, networks that rely on satellite links.

### BACKGROUND

There are a variety of different types of communication networks, such as terrestrial-based wireless communication networks and satellite communication networks. Terrestrial-based wireless communication networks are commonly known as cellular networks. Compared to terrestrial-based communication networks (wired or wireless), satellite communication networks have a number of drawbacks, including the expense of the satellites. An additional problem with satellite communication networks is the large latency associated with the time required for information to travel between a land-based communication device and the satellite. This delay is then repeated for the transmission of the communication from the satellite back down to another communication device. The delay introduced due to the satellite communication links begins on the order of 500 ms and can exceed 2,500 ms. Evidently this affects the performance of a browser when used as part of a computer or mobile devices relying on a satellite communications network, and thus the speed with which a user can access information through the browser.

Not long-ago satellite communication networks did not provide quality of service (“QoS”) mechanisms to account for delays and/or packet loss. Current methods for calculating a QoS metric are based on bandwidth available. In light of the foregoing, there is a need in the art for measuring a QOE metric accurately which can be used by a network manager to manage network resources in a more efficient manner.

### SUMMARY

The following presents a simplified summary of the disclosure in order to provide a basic understanding of some aspects of the disclosure. This summary is not an extensive overview of the disclosure. It is not intended to identify key, or critical, elements of the disclosure or delineate the scope of the disclosure. Its sole purpose is to present some concepts of the disclosure in a simplified form as a prelude to the more detailed description that is presented later.

Disclosed is a method and system for measuring and reporting the experience a user may perceive while using a communications network while aboard a plane or cruise, for example, and thus reliant on satellite communication links. In that regards, the system and method may operate in a manner similar to an Internet speed-test, which provides the user with an estimate of the bandwidth that a network provides, and thus gives the user an idea of perceived experience. The present invention provides much more advanced features than a simple speed test, as underlying network parameters in addition to bandwidth are factored in the calculation of the QOE. For example, the QOE score produced by the present system and method takes into account the latency, packet loss, jitter, network congestion, and DNS failure of the network as well. Thus, the present invention provides a near complete measurement of the experience the end user may have. The QOE measurement may then be used by a network manager to reassign resources and/or to ascertain whether service levels are being met.

In certain embodiments, a method for training a machine learning model to generate a quality of experience (QOE) score that may include providing a machine learning module with a data set comprising QOE data, wherein the QOE data comprises a set of pairings or a communication timing statistic and an associated human user feedback QOE score for the communication timing statistic. The machine learning module may be trained on the QOE data to generate QOE scores for each of the pairings of communication timing statistics and human user feedback QOE scores to minimize error, where error may be the aggregated difference of generated QOE scores and the human user feedback QOE scores.

In certain embodiments, a method for calculating a QOE score from a communication timing statistic may include generating a QOE score considering a DNS component, a TCP component, a TLS component, a latency component, and a data rate component.

In certain embodiments, a method for generating a quality of experience score from a curl probe statistic may include a QOE Score calculated as the max of zero and 0 and a weighted sum, Wgt_DNS*(max(0, DNS_time_ms-Alpha_DNS)*(Beta_DNS)+100)+Wgt_TCP*(max (0, TCP_time_ms-Alpha_TCP)*(Beta_TCP)+100)+Wgt_TLS*(max(0, TLS_time_ms-Alpha_TLS)*(Beta_TLS)+100)+Wgt_Latency*(Latency_time_ms*(Beta_Latency)+100)+Wgt_DR*(76.92-461.53*1.01\hat{ }(Beta_DR*min (Effective_data_rate_kbps, Alpha_DR)). The curl probe statistic may include DNS_time_ms (DNS time in milliseconds), TCP_time_ms (TCP time in milliseconds), TLS_time_ms (TLS time in milliseconds), TTFB_time_ms (TTFB time in milliseconds), total_time_ms (total time in milliseconds) and data_size. Latency_time_ms may be calculated as the difference between the TTFB_time_ms and TLS_time_ms. Effective_data_rate_kbps may be calculated as the data_size divided by the difference between total_time_ms and tls_time_ms, and may be expressed as kilobits per second. Wgt_DNS may be a weight to be assigned to DNS time. Wgt_TCP may be a weight to be assigned to TCP time. Wgt_TLS may be a weight to be assigned to effective latency. Wgt_DR may be a weight to be assigned to effective data range. Alpha_DNS may be a threshold DNS time below which DNS_time_ms is irrelevant. Alpha_TCP may be a threshold TCP time below which TCP_time_ms is irrelevant. Alpha_TLS may be a threshold TLS time below which TLS_time_ms is irrelevant. Alpha_DR may be a threshold data rate above which Effective_data_rate_kbps is irrelevant. Beta_DNS may be a factor for the rate at which DNS_time_ms above Alpha DNS affects the QOE Score. Beta_TCP may be a factor for the rate at which TCP_time_ms above Alpha_TCP affects the QOE Score. Beta_TLS may be a factor for the rate at which TLS_time_ms above Alpha_TLS affects the QOE Score. Beta_DR may be a factor for the rate at which Effective_data_rate_kbps below Alpha_DR affects the QOE Score.

In certain embodiments, a method for generating a quality of experience score from a curl probe statistic may include calculating a QOE Score as the max of 0, and a weighted sum, 0.1*(max(0, DNS_time_ms-500)*(−0.0713)+100)+0.13*(max(0, TCP_time_ms-500)*(−0.0425)+100)+0.25 (max(0, TLS_time_ms-500)*(−0.04)+100)+0.37*(Latency_time_ms *(−0.02)+100)+0.13*(76.92−461.53*1.01\hat{ }(−0.78*min (Effective_data_rate_kbps, 500). The curl probe statistic may include DNS_time_ms (DNS time in milliseconds), TCP_time_ms (TCP time in milliseconds), TLS_time_ms (TLS time in milliseconds), TTFB_time_ms (TTFB time in milliseconds), total_time_ms (total time in milliseconds) and data_size. Latency_time_ms may be calculated as the difference between the TTFB_time_ms and TLS_time_ms. Effective_data_rate_kbps may be calculated as the data_size divided by the difference between total_time_ms and tls_time_ms expressed as kilobits per second.

The following description and drawings set forth in detail certain illustrative aspects of the disclosure. These aspects are indicative, however, of but a few of the various ways in which the principles of the disclosed system and method may be employed and the present disclosure is intended to include all such aspects and their equivalents. Other advantages and novel features of the disclosed system and method will become apparent from the following description of the subject matter disclosed herein when considered in conjunction with the drawings.

### BRIEF DESCRIPTION OF THE DRAWINGS

The drawings set forth exemplary embodiments of the disclosed concepts and are not intended to be limiting in any way.

FIG. 1 illustrates a timing diagram for a communication of information obtainable from a curl probe.

FIG. 2 illustrates a machine learning software module used to calculate the QOE score.

### DETAILED DESCRIPTION

The following detailed description and the appended drawings describe and illustrate exemplary embodiments solely for the purpose of enabling one of ordinary skill in the relevant art to make and use the invention. As such, the detailed description and illustration of these embodiments are purely exemplary in nature and are in no way intended to limit the scope of the invention, or its protection, in any manner. It should also be understood that the drawings are not to scale and in certain instances details have been omitted, which are not necessary for an understanding of the present invention, such as conventional details of fabrication and assembly.

In certain embodiments, a method for training a machine learning model to generate a quality of experience (QOE) score that may include providing a machine learning module with a data set comprising QOE data, wherein the QOE data comprises a set of pairings or a communication timing statistic and an associated human user feedback QOE score for the communication timing statistic. The machine learning module may be trained on the QOE data to generate QOE scores for each of the pairings of communication timing statistics and human user feedback QOE scores to minimize error, where error may be the aggregated difference of generated QOE scores and the human user feedback QOE scores.

In certain embodiments, the communication timing statistic in the QOE data may include a curl probe statistic. In certain embodiments, t he curl probe statistics may include a DNS time, a TCP time, a TTFB, a total time and data size. In certain embodiments, training the machine learning module to generate QOE scores for each of the pairings of communication timing statistics and human user feedback QOE Scores to minimize error may include using the DNS time, the TCP Time, the TLS time, effective latency and effective data rate. In certain embodiments, the effective latency may be the difference between the TTFB time and the TLS time. In certain embodiments, the effective data rate may be the data size divided by the difference between total time and TLS time. In certain embodiments, training the machine learning module to generate QOE scores for each of the pairings of communication timing statistics and human user feedback QOE scores to minimize error may include generating a weight to be given to DNS time (Wgt_DNS). In certain embodiments, training the machine learning module to generate QOE scores for each of the pairings of communication timing statistics and human user feedback QOE scores to minimize error may include generating a weight to be given to TCP time (Wgt_TCP). In certain embodiments, training the machine learning module to generate QOE scores for each of the pairings of communication timing statistics and human user feedback QOE scores to minimize error may include generating a weight to be given to TLS time (Wgt_TLS). In certain embodiments, training the machine learning module to generate QOE scores for each of the pairings of communication timing statistics and human user feedback QOE Scores may include generating a weight to be given to effective latency (Wgt_Latency). In certain embodiments, training the machine learning module to generate QOE scores for each of the pairings of communication timing statistics and human user feedback QOE Scores may include generating a weight to be given to effective data rate (Wgt_DR).

In certain embodiments, training the machine learning module to generate QOE scores for each of the pairings of communication timing statistics and human user feedback QOE scores to minimize error may include generating a threshold for DNS time (Alpha_DNS) below which DNS time has no effect on the QOE score. In certain embodiments, training the machine learning module to generate QOE scores for each of the pairings of communication timing statistics and human user feedback QOE scores to minimize error may include generating a threshold for TCP time (Alpha_TCP)) below which TCP time has no effect on the QOE score. In certain embodiments, training the machine learning module to generate QOE scores for each of the pairings of communication timing statistics and human user feedback QOE scores to minimize error may include generating a threshold for TLS time (Alpha_TLS) below which the TLS time has no effect on the QOE score. In certain embodiments, training the machine learning module to generate QOE scores for each of the pairings of communication timing statistics and human user feedback QOE scores to minimize error may include generating a threshold data rate (Alpha_DR) above which effective data rate has no effect on QOE Score.

In certain embodiments, training the machine learning module to generate QOE scores for each of the pairings of communication timing statistics and human user feedback QOE scores to minimize error may include generating a DNS factor (Beta_DNS) for the effect of DNS time that is greater than a threshold DNS time (Alpha_DNS) on the QOE score. In certain embodiments, training the machine learning module to generate QOE scores for each of the pairings of communication timing statistics and human user feedback QOE scores to minimize error may include generating a TCP factor (Beta_TCP) for the effect of TCP time that is greater than a threshold TCP time (Alpha_TCP) on the QOE score. In certain embodiments, training the machine learning module to generate QOE scores for each of the pairings of communication timing statistics and human user feedback QOE scores to minimize error may include generating a TLS factor (Beta_TLS) for the effect of TLS time that is greater than a threshold TLS time (Alpha_TLS) on the QOE score. In certain embodiments, training the machine learning module to generate QOE scores for each of the pairings of communication timing statistics and human user feedback QOE scores to minimize error may include generating a latency factor (Beta_Latency) for the effect of effective latency on the QOE score. In certain embodiments, training the machine learning module to generate QOE scores for each of the pairings of communication timing statistics and human user feedback QOE scores to minimize error comprises generating a data rate factor (Beta_DR) for the effect of effective data rate below a threshold data rate (Alpha_DR) on the QOE score.

In certain embodiments, training the machine learning module to generate QOE scores for each of the pairings of communication timing statistics and human user feedback QOE scores to minimize error may include generating a weight to be given to DNS time (Wgt_DNS); generating a weight to be given to TCP time (Wgt_TCP); generating a weight to be given to TLS time (Wgt_TLS); generating a weight to be given to effective latency (Wgt_latency); generating a weight to be given to effective data rate (Wgt_DR). In certain embodiments, the weights for DNS time, TCP time, TLS time, effective latency and data rate may be normalized to sum to 1. In certain embodiments, training the machine learning module to generate QOE scores for each of the pairings of communication timing statistics and human user feedback QOE scores to minimize error may include generating thresholds for DNS time (Alpha_DNS), TCP time (Alpha_TCP), and TLS time (Alpha_TLS) below which the DNS time, TCP time and TLS time have no effect on QOE score. In certain embodiments, training the machine learning module to generate QOE scores for each of the pairings of communication timing statistics and human user feedback QOE scores to minimize error may include generating a threshold data rate (Alpha_DR) above which effective data rate has no effect on QOE Score.

In certain embodiments, training the machine learning module to generate QOE scores for each of the pairings of communication timing statistics and human user feedback QOE scores to minimize error may include generating a DNS factor (Beta_DNS), a TCP factor (Beta_TCP), and a TLS factor (Beta_TNS) for the effect of DNS time, TCP Time, and TLS time that is greater than a threshold DNS time (Alpha_DNS), threshold TCP time (Alpha_TCP) and threshold TLS time (Alpha_TLS), respectively, on the QOE score, and generating a latency factor (Beta_Latency) for the effect of effective latency on the QOE score, and a data rate factor (Beta_DR) for the effect of effective data rate below a threshold data rate (Alpha_DR) on the QOE score.

In certain embodiments, a method for calculating a QOE score from a communication timing statistic may include generating a QoE score considering of a DNS component, a TCP component, a TLS component, a latency component, and a data rate component.

In certain embodiments, the DNS component may include a weight (Wgt_DNS). In certain embodiments the DNS component weight (Wgt_DNS) may be 0.1. In certain embodiments, the DNS component may include a threshold (Alpha_DNS) below which DNS time does not effect the QOE score. In certain embodiments, the DNS component threshold (Alpha_DNS) may be 500 ms. In certain embodiments, the DNS component may include a factor (Beta_DNS) for the effect of DNS time above the threshold on QOE Score. In certain embodiments, the DNS component factor (Beta_DNS) may be negative. In certain embodiments, the DNS component factor (Beta_DNS) may be −0.0713. In certain embodiments, DNS component may include the multiplication of the DNS factor (Beta_DNS) with the max of 0 and the difference between DNS time (DNS_time_ms) from a curl probe statistic and the DNS threshold (Alpha_DNS). In certain embodiments the DNS component may include a base score of 100. In certain embodiments, the DNS component may include Wgt_DNS*(max(0, DNS_time_ms-Alpha_DNS)*(Beta_DNS)+100). In certain embodiments, the DNS component may include 0.1*(max(0, DNS_time_ms−500)*(−0.0713)+100).

In certain embodiments, the TCP component may include a weight (Wgt_TCP). In certain embodiments the TCP component weight (Wgt_TCP) may be 0.15. In certain embodiments, the TCP component may include a threshold (Alpha_TCP) below which TCP time does not effect the QOE score. In certain embodiments, the TCP component threshold (Alpha_TCP) may be 500 ms. In certain embodiments, the TCP component may include a factor (Beta_TCP) for the effect of TCP time above the threshold on QOE Score. In certain embodiments, the TCP component factor (Beta_TCP) may be negative. In certain embodiments, the TCP component factor (Beta_TCP) may be −0.0425. In certain embodiments, TCP component may include the multiplication of the TCP factor (Beta_TCP) with the max of 0 and the difference between TCP time (TCP_time_ms) from a curl probe statistic and the TCP threshold (Alpha_TCP). In certain embodiments the TCP component may include a base score of 100. In certain embodiments, the TCP component may include Wgt_TCP*(max(0, TCP_time_ms-Alpha_TCP)*(Beta_TCP)+100). In certain embodiments, the TCP component may include 0.13*(max(0, TCP_time_ms-500)*(−0.0425)+100).

In certain embodiments, the TLS component may include a weight (Wgt_TLS). In certain embodiments the TLS component weight (Wgt_TLS) may be 0.25. In certain embodiments, the TLS component may include a threshold (Alpha_TLS) below which TLS time does not effect the QOE score. In certain embodiments, the TLS component threshold (Alpha_TLS) may be 500 ms. In certain embodiments, the TLS component may include a factor (Beta_TLS) for the effect of TLS time above the threshold on QOE Score. In certain embodiments, the TLS component factor (Beta_TLS) may be negative. In certain embodiments, the TLS component factor (Beta_TLS) may be −0.04. In certain embodiments, TLS component may include the multiplication of the TLS factor (Beta_TLS) with the max of 0 and the difference between TLS time (TLS_time_ms) from a curl probe statistic and the TLS threshold (Alpha_TLS). In certain embodiments the TLS component may include a base score of 100. In certain embodiments, the TLS component may include Wgt_TLS*(max(0, TLS_time_ms-Alpha_TLS)*(Beta_TLS)+100). In certain embodiments, the TLS component may include 0.25 (max(0, TLS_time_ms-500)*(−0.04)+100).

In certain embodiments, the latency component may include a weight (Wgt_Latency). In certain embodiments the latency component weight (Wgt_latency) may be 0.37. In certain embodiments, the latency component may include a factor (Beta_Latency) for the effect of latency above the threshold on QOE Score. In certain embodiments, the latency component factor (Beta_latency) may be negative. In certain embodiments, the latency component factor (Beta_latency) may be −0.02. In certain embodiments the Latency component may include an effective latency (Latency_time_ms) calculated as the difference between the TTFB_time_ms and TLS_time_ms from a curl probe statistic. In certain embodiments, latency component may include the multiplication of the latency factor (Beta_latency) the effective latency (Latency_time_ms). In certain embodiments the DNS component may include a base score of 100. In certain embodiments, the latency component may include Wgt_Latency*(Latency_time_ms*(Beta_Latency)+100). In certain embodiments, the latency component may include 0.37*(Latency_time_ms*(−0.02)+100)

In certain embodiments, the data rate component may include a weight (Wgt_DR). In certain embodiments, the data rate component weight may be 0.13. In certain embodiments, the data rate component may include a threshold rate (Alpha_DR) above which the effective data rate has no effect on QOE score. In certain embodiments, the data rate component threshold (Alpha_DR) may be 500 kilobits per second (kbps). In certain embodiments, data rate component may include). In certain embodiments, the data rate component may include a factor (Beta_DR) for the effect of data rates below the threshold on QOE Score. In certain embodiments the data rate factor (Beta_DR) may be −0.78. In certain embodiments, the data rate component may include an effective data rate (Effective_data_rate_kbps), which may be calculated as the data_size divided by the difference between total_time_ms and tls_time_ms from a curl probe statistic, and may be expressed as kilobits per second. In certain embodiments, the data rate component may include a base data rate score (Base_DRScore), a base data rate penalty (Base_DRPenalty), and an exponent base (Exponent_Base). In certain embodiments, the base data rate score may be 76.92. In certain embodiments, the base data rate penalty may be −461.53. In certain embodiments the exponent base may be 1.01. In certain embodiments, the data rate component may include the sum of the base data rate score (Base_DRScore) with the base data rate penalty (Base_DRPenalty) and multiplied by the result of the exponent base to the power of the data component factor (Beta_DR) multiplied by the minimum of the effective data rate (Effective_data_rate_kbps) and the threshold data rate (Alpha_DR). In certain embodiments, the data rate component may include Base_DRScore+Base_DRPenalty*Exponent_Base\hat{ }(Beta_DR*min (Effective_data_rate_kbps, Alpha_DR). In certain embodiments, the data rate component may include 76.92-461.53*1.01\hat{ } (Beta_DR*min (Effective_data_rate_kbps, Alpha_DR). In certain embodiments, the data rate component may include 0.13*(76.92-461.53*1.01\hat{ }(−0.78*min (Effective_data_rate_kbps, 500).

In certain embodiments the DNS component, TCP component, TLS component, latency component and data rate component may each have a weight (Wgt_DNS, Wgt_TCP, Wgt_TLS, Wgt_Latency, Wgt_DR). In certain embodiments the weights for the DNS component, TCP component, TLS component, latency component and data rate component may be normalized so that they sum to 1. In certain embodiments, generating a QoE score considering a DNS component, a TCP component, a TLS component, a latency component, and a data rate component may include the QOE score being the max of 0 and a weighted sum of the DNS component, the TCP component, the TLS component, the latency component, and the data rate component.

In certain embodiments, a method for generating a quality of experience score from a curl probe statistic may include a QOE Score calculated as the max of zero and 0 and a weighted sum, Wgt_DNS*(max(0, DNS_time_ms-Alpha_DNS)*(Beta_DNS)+100)+Wgt_TCP*(max (0, TCP_time_ms-Alpha_TCP)*(Beta_TCP)+100)+Wgt_TLS*(max(0, TLS_time_ms-Alpha_TLS)*(Beta_TLS)+100)+Wgt_Latency*(Latency_time_ms*(Beta_Latency)+100)+Wgt_DR*(76.92-461.53*1.01\hat{ }(Beta_DR*min (Effective_data_rate_kbps, Alpha_DR)). The curl probe statistic may include DNS_time_ms (DNS time in milliseconds), TCP_time_ms (TCP time in milliseconds), TLS_time_ms (TLS time in milliseconds), TTFB_time_ms (TTFB time in milliseconds), total_time_ms (total time in milliseconds) and data_size. Latency_time_ms may be calculated as the difference between the TTFB_time_ms and TLS_time_ms. Effective_data_rate_kbps may be calculated as the data_size divided by the difference between total_time_ms and tls_time_ms, and may be expressed as kilobits per second. Wgt_DNS may be a weight to be assigned to DNS time. Wgt_TCP may be a weight to be assigned to TCP time. Wgt_TLS may be a weight to be assigned to effective latency. Wgt_DR may be a weight to be assigned to effective data range. Alpha_DNS may be a threshold DNS time below which DNS_time_ms is irrelevant. Alpha_TCP may be a threshold TCP time below which TCP_time_ms is irrelevant. Alpha_TLS may be a threshold TLS time below which TLS_time_ms is irrelevant. Alpha_DR may be a threshold data rate above which Effective_data_rate_kbps is irrelevant. Beta_DNS may be a factor for the rate at which DNS_time_ms above Alpha DNS affects the QOE Score. Beta_TCP may be a factor for the rate at which TCP_time_ms above Alpha_TCP affects the QOE Score. Beta_TLS may be a factor for the rate at which TLS_time_ms above Alpha_TLS affects the QOE Score. Beta_DR may be a factor for the rate at which Effective_data_rate_kbps below Alpha_DR affects the QOE Score.

In certain embodiments, a method for generating a quality of experience score from a curl probe statistic may include calculating a QOE Score as the max of 0, and a weighted sum, 0.1*(max(0, DNS_time_ms-500)*(−0.0713)+100)+0.13*(max(0, TCP_time_ms-500)*(−0.0425)+100)+0.25 (max(0, TLS_time_ms-500)*(−0.04)+100)+0.37*(Latency_time_ms*(−0.02)+100)+0.13*(76.92-461.53*1.01\hat{ }(−0.78*min (Effective_data_rate_kbps, 500). The curl probe statistic may include DNS_time_ms (DNS time in milliseconds), TCP_time_ms (TCP time in milliseconds), TLS_time_ms (TLS time in milliseconds), TTFB_time_ms (TTFB time in milliseconds), total_time_ms (total time in milliseconds) and data_size. Latency_time_ms may be calculated as the difference between the TTFB_time_ms and TLS_time_ms. Effective_data_rate_kbps may be calculated as the data_size divided by the difference between total_time_ms and tls_time_ms expressed as kilobits per second.

In one embodiment, the method and system of the present invention can be used to generate a QOE metric based on browsing or browser performance when the corresponding computer or mobile devices accesses data through a satellite network. The system and method take into account that the QOE changes over time, for example, during a trip, as the signal coverage changes depending on different geographical zones and on the weather, for example. The QOE may be calculated for an entire fleet of airplanes or ships, for example. In one embodiment, the QOE may be calculated on a website-by-website basis.

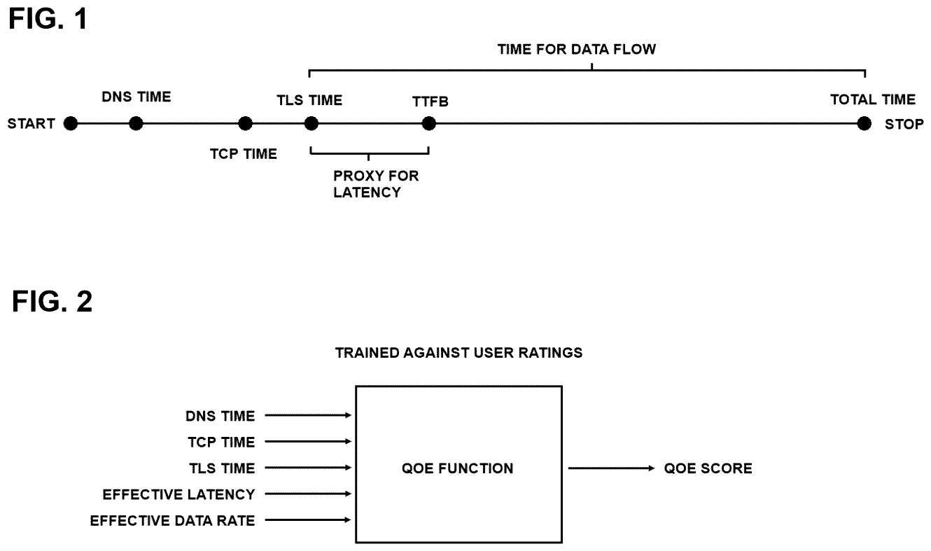

In one embodiment, the system of the present invention may include a software module used to collect a curl probe statistic of a given website/URL and then pass it to a software module that implements the QOE function that generates an output score between 0 to 100. FIG. 1 illustrates a time diagram of the metrics that may be obtained from the curl probe. The curl probe may be run on a server (as opposed to the user's device) that is on board the ship, airplane, train, etc.

Referring to FIG. 1, DNS Time may be defined as the Domain Name Server lookup time, which is the time it takes a Domain Name Server to receive the request for a domain name's IP address, process it, and return the IP address to the browser.

TCP Time may be defined as the time it takes to establish a TCP connection to the host server.

TLS Time may be defined as Transport Layer Security time, which is the time it takes to perform a TLS handshake. During a TLS handshake, the host server and the end user device exchange messages to acknowledge and verify each other, establish which encryption algorithm will be used, and agree on session keys.

TTFB may be defined as the time to first byte. This metric relates to the duration from the user or client making an HTTP request to the first byte of the page being received by the client's browser.

Proxy for latency or Effective Latency may be defined as a metric which is the difference between the TTFB and the TLS Time.

Total time may be defined as the total time it takes from the moment in which a user requests content from a device until all of the content has been downloaded into the end user's browser.

Time for data to flow may be defined as a metric which is the difference between the Total Time and the TLS Time.

In one embodiment where the communications network relies on use of satellite links, such networks have very high latencies (In range of 800 to 1000 ms), and the data rate calculated by using a traditional formula provides a wrong interpretation of the network performance. For example, assuming that the total session time is 3 seconds and the latency of the network is 1000 ms, in that case ⅓ time is spent just to establish the first contact. If the TLS handshake takes about 500 ms, then 50% of the time is spent in establishing a connection and the rest 50% of the time actually results in data transition/delivery. And if more or less 30,000 bytes are delivered, then the data rate of the network would be around:

$$Data Rate = Total Bits / Total Time ( in sec ) = 3 \; 0000 ⋆ 8 / 3 = 80 kbps$$

However, that calculation provides a wrong picture of the data rate, since 50% of the time is just spent in establishing a connection, unlike in terrestrial networks where this value is significantly lower than the session time such that it could fairly be ignored. Thus, there is a need for a novel method to arrive at a near correct value, one which, in accordance with the present invention, considers only that time when the data flow took place, for example:

Effective Data Rate=Total Bits/(Total Time-TLS time)=30000*8/(3-1.5)=160 kbps

The latency of the network can also be inferred for the curls statistics or metrics. A very good proxy for the latency is the time a byte takes after the handshake is made until the byte reaches the client's end. This is the time difference between TTFB (Time to first byte)—TLS handshake time.

$$Effective Latency = TTFB - TLS time$$

The QOE scores may be calculated based on these metrics. All these metrics may then be collected over real world satellite networks over different time zones, at different times and over different GEO locations.

FIG. 2 illustrates a machine learning software module used to calculate the QOE score based on the following metrics: DNS Time, TCP Time, TLS Time, Effective Latency, and Effective Data Rate. In addition, the module may be trained against individual end-user inputs regarding their ratings of the service. Persons of skill in the art will recognize that any machine learning software module known in the art or to be developed may be used to implement the disclosed concepts including, but not limited to, neural networks, decision trees, Naïve Bayes classification, regression algorithms, clustering algorithms (K-Means, heirarchichal, probabilistic), etc. These learning modules may be trained in any way known in the art or to be developed including, but not limited to, supervised learning, unsupervised learning, semi-supervised learning, self-supervised and reinforcement learning, or through deep learning methodologies against individual end-user inputs regarding their ratings of the service. The invention allows the calculation of QOE using the smallest possible bandwidth (e.g., 64 kbits) by relying on the framework of the web page getting the main java script.

There are different approaches for the collection of data used to calculate the QOE score.

Data may be collected on-site, which means that engineers or technical personnel are sent onboard ships and flights (travel as a customer onboard) with machines preinstalled with the QOE software module, with data being collected across all the metrics. These engineers may provide a score between 0 to 10 regarding the experience they have had while browsing on the vehicle.

Data may be collected off-site. Engineers or technical personnel may get a feel of the network by browsing through a virtual machine (“VM”) hosted on a ship or airplane and thereby taking feedback from them regarding the experience they are having (e.g., providing a score between 0 to 10).

Data may also be collected by the cruise or airline carrier as described above with respect to the on-site data collection (end user is an employee or agent of carrier that share their feedback—providing a score between 0 and 10).

All collected data may then be merged with data from terrestrial and LEO networks and consolidated into a single source. In one embodiment all data may be collected regularly at fixed intervals and then the feedback data is used to tune the QOE score calculation (which relies on both metrics and feedback data).

The QOE machine learning software module may be used to generate a formula for calculating the QOE score which minimizes the error between the output QOE and user feedback, and at the same time be simple enough to be easily deployed and interpreted. Error may be defined as the difference between the QOE score provided in the user feedback for a set of curl probe data and the QOE score generated by the machine learning software module for that set of curl data, aggregated across the entire user feedback data set.

Following is a generalized exemplary formula against which parameters are then tuned in regular intervals of time:

$$QOE = max ( 0 , Wgt\_DNS ⋆ ( max ( 0 , DNS\_time \_ms - Alpha\_DNS ) ⋆ ( Beta\_DNS ) + 100 ) + Wgt\_TCP ⋆ ( max ( 0 , TCP\_time \_ms - Alpha\_TCP ) ⋆ ( Beta\_TCP ) + 100 ) + Wgt\_TLS ⋆ ( max ( 0 , TLS\_time \_ms - Alpha\_TLS ) ⋆ ( Beta\_TLS ) + 100 ) + Wgt\_Latency ⋆ ( Latency\_time \_ms ⋆ ( Beta\_Latency ) + 100 ) + \text{} Wgt\_DR ⋆ ( 76.92 - \text{} 461.53 ⋆ 1.01 ⋀ ( Beta\_DR ⋆ min ( Effective\_data \_rate \_kbps , Alpha\_DR ) )$$

The following variable definitions apply to the formula:

1) Wgt_DNS: Signifies the weight given to DNS time compared to all other 4 input parameters.

2) Wgt_TCP: Signifies the weight given to TCP time compared to all other 4 input parameters.

3) Wgt_TLS: Signifies the weight given to TLS time compared to all other 4 input parameters.

4) Wgt_Latency: Signifies the weight given to effective latency, compared to all other 4 input parameters.

5) Wgt_DR: Signifies the weight given to effective data rate, compared to all other 4 input parameters.

6) These five weight parameters may be normalized such that Wgt_DNS+Wgt_TCP+Wgt_TLS+Wgt_Latency+Wgt_DR=1. The sum of all the weights should sum up to 1, otherwise the score would be greater than 100 in the very best scenarios.

3) Alpha_DNS, Alpha_TCP and Alpha_TLS: May be defined as the cutoff value for DNS, TCP and TLS, respectively, after which its effect on user experience is felt. For example, a value of 500 ms means DNS, TCP and TLS time lower than 500 ms has no effect on QOE. Only when the times are above this value, their effect starts to be noticed.

4) Alpha_DR is a data rate above which data rate has no effect on QOE. For example, a vale of 500 kbps means that an effective data rate above 500 kilobits per second has no effect on QOE. Only when the data rate is below this threshold does the effective data rate's effect start to be noticed.

5) Beta_DNS, Beta_TCP, Beta_TLS, Beta_Latency, and Beta_DR: May be defined as the rate at which an increase in DNS time, TCP time, TLS time, effective latency or effective data rate take its toll on the QOE score, since QOE score and DNS time are negatively correlated, the value of this parameter would be negative—the higher the value higher the penalty with every unit increase in milli seconds.

6) Wgt_DNS*(max(0, DNS_time_ms-Alpha_DNS)*(Beta_DNS)+100)−The value of this line would be at max Wgt_DNS*100 while the minimum could be negative infinity, that's where QOE function is trimmed at 0 whenever the score goes below zero.

7) Wgt_DR*(76.92-461.53*1.01\hat{ }(Beta_DR*min (Effective_data_rate_kbps, Alpha_DR))—The Effective_data_rate_kbps is capped at Alpha_DR, and any value greater than this is trimmed to this value. The line decides the extent to which an S-curve pattern can be observed. While the function itself is a modelling a S-curve, which is very common in economics and other fields where very low values can't have differentiable satisfaction and similar is the case with higher values, the middle values cater to the elasticity of experience.

Following is the formula with all the parameters being tuned:

$$QOE = max ( 0 , 0 \text{.1} ⋆ ( max ( 0 , DNS\_time \_ms - 5 \; 00 ) ⋆ ( - 0.0713 ) + 100 ) + 0.15 ⋆ ( max ( 0 , TCP\_time \_ms - 5 \; 00 ) ⋆ ( - 0.0425 ) + 100 ) + 0.2 5 ( max ( 0 , TLS\_time \_ms - 5 \; 00 ) ⋆ ( - 0.04 ) + 100 ) + 0. 37 ⋆ ( Latency\_time \_ms ⋆ ( - 0.02 ) + 100 ) + 0.13 ( 76.92 - 461.53 ⋆ 1.01 ⋀ ( - 0.78 ⋆ min ( Effective\_data \_rate \_kbps , 500 ) )$$

The following can be inferred from the formula for calculating the QOE score.

1) Weightage for latencies is around 87%

2) Following Data rate helps in tuning the score since, TTFB also gets affected because of available throughput and thus indirectly caters to it, this additional parameter helps differentiate a scenario occurring due to actual high latency or due low data rate.

3) Since TLS includes TCP and DNS similarly TCP includes DNS, failure of DNS impacts all the 3 parts of the formula and hence a heavy penalty is placed.

4) In addition, this also helps in segregating the scenarios where for example a session gets completed in 5 seconds and then 2 possibilities exist, first where pages start loading at 4.5 seconds and completes at 5 seconds, and second, page starts loading at 2 seconds and completes in 5 seconds, in this example the second case has the higher QOE because the user is getting to see partial page much before than in the first case.

5) Latency in the network is of the highest importance, this is because this only helps segregate the behavior LEO/Terrestrial to that of SATCOM (satellite link network) barring other variables as constant.

We claim:

1. A method for training a machine learning model to generate a quality of experience (QOE) score comprising:
providing a machine learning module with a data set comprising QOE data, wherein the QOE data comprises a set of pairings or a communication timing statistic and an associated human user feedback QOE score for the communication timing statistic;
training the machine learning module on the QOE data to generate QOE scores for each of the pairings of communication timing statistics and human user feedback QOE scores to minimize error, where error comprises the aggregated difference of generated QOE scores and the human user feedback QOE scores.

2. The method of claim 1 wherein the communication timing statistic in the QOE data comprise curl probe statistics.

3. The method of claim 1 wherein the curl probe statistics comprise a DNS time, a TCP time, a TTFB, a total time and data size.

4. The method of claim 3 wherein the training the machine learning module to generate QOE scores for each of the pairings of communication timing statistics and human user feedback QOE Scores to minimize error comprises using the DNS time, the TCP Time, the TLS time, effective latency and effective data rate, wherein effective latency comprises the difference between the TTFB time and the TLS time, and effective data rate comprises the data size divided by the difference between total time and TLS time.

5. The method of claim 4 wherein the training the machine learning module to generate QOE scores for each of the pairings of communication timing statistics and human user feedback QOE scores to minimize error comprises generating a weight to be given to DNS time (Wgt_DNS).

6. The method of claim 4 wherein the training the machine learning module to generate QOE scores for each of the pairings of communication timing statistics and human user feedback QOE scores to minimize error comprises generating a weight to be given to TCP time (Wgt_TCP).

7. The method of claim 4 wherein the training the machine learning module to generate QOE scores for each of the pairings of communication timing statistics and human user feedback QOE scores to minimize error comprises generating a weight to be given to TLS time (Wgt_TLS).

8. The method of claim 4 wherein the training the machine learning module to generate QOE scores for each of the pairings of communication timing statistics and human user feedback QOE Scores comprises generating a weight to be given to effective latency (Wgt_Latency).

9. The method of claim 4 wherein the training the machine learning module to generate QOE scores for each of the pairings of communication timing statistics and human user feedback QOE Scores comprises generating a weight to be given to effective data rate (Wgt_DR).

10. The method of claim 4 wherein the training the machine learning module to generate QOE scores for each of the pairings of communication timing statistics and human user feedback QOE scores to minimize error comprises:
generating a weight to be given to DNS time (Wgt_DNS);
generating a weight to be given to TCP time (Wgt_TCP);
generating a weight to be given to TLS time (Wgt_TLS);
generating a weight to be given to effective latency (Wgt_latency);
generating a weight to be given to effective data rate (Wgt_DR).

11. The method of claim 10 wherein the weights for DNS time, TCP time, TLS time, effective latency and data rate are normalized to sum to 1.

12. The method of claim 4 wherein the training the machine learning module to generate QOE scores for each of the pairings of communication timing statistics and human user feedback QOE scores to minimize error comprises generating thresholds for DNS time (Alpha_DNS), TCP time (Alpha_TCP), and TLS time (Alpha_TLS) below which the DNS time, TCP time and TLS time have no effect on QOE score.

13. The method of claim 4 wherein the training the machine learning module to generate QOE scores for each of the pairings of communication timing statistics and human user feedback QOE scores to minimize error comprises generating a threshold rate above which effective data rate has no effect on QOE Score.

14. The method of claim 4 wherein the training the machine learning module to generate QOE scores for each of the pairings of communication timing statistics and human user feedback QOE scores to minimize error comprises generating a DNS factor (Beta_DNS) for the effect of DNS time that is greater than a threshold DNS time (Alpha_DNS) on the QOE score.

15. The method of claim 4 wherein the training the machine learning module to generate QOE scores for each of the pairings of communication timing statistics and human user feedback QOE scores to minimize error comprises generating a TCP factor (Beta_TCP) for the effect of TCP time that is greater than a threshold TCP time (Alpha_TCP) on the QOE score.

16. The method of claim 4 wherein the training the machine learning module to generate QOE scores for each of the pairings of communication timing statistics and human user feedback QOE scores to minimize error comprises generating a TLS factor (Beta_TLS) for the effect of TLS time that is greater than a threshold TLS time (Alpha_TLS) on the QOE score.

17. The method of claim 4 wherein the training the machine learning module to generate QOE scores for each of the pairings of communication timing statistics and human user feedback QOE scores to minimize error comprises generating a latency factor (Beta_Latency) for the effect of effective latency on the QOE score.

18. The method of claim 4 wherein the training the machine learning module to generate QOE scores for each of the pairings of communication timing statistics and human user feedback QOE scores to minimize error comprises generating a data rate factor (Beta_DR) for the effect of effective data rate below a threshold data rate (Alpha_DR) on the QOE score.

19. A method for generating a quality of experience score from a curl probe statistic comprising:
$$QOE Score = max ( 0 , Wgt\_DNS ⋆ ( max ( 0 , DNS\_time \_ms - Alpha\_DNS ) ⋆ ( Beta\_DNS ) + 100 ) + Wgt\_TCP ⋆ ( max ( 0 , TCP\_time \_ms - Alpha\_TCP ) ⋆ ( Beta\_TCP ) + 100 ) + Wgt\_TLS ⋆ ( max ( 0 , TLS\_time \_ms - Alpha\_TLS ) ⋆ ( Beta\_TLS ) + 100 ) + Wgt\_Latency ⋆ ( Latency\_time \_ms ⋆ ( Beta\_Latency ) + 100 ) + Wgt\_DR ⋆ ( 76.92 - \text{} 461.53 ⋆ \text{} 1.01 ⋀ \text{} ( Beta\_DR ⋆ \text{} min ( \text{} Effective\_data \text{} \_rate \text{} \_kbps , Alpha\_DR ) ) ,$$
wherein the curl probe statistic comprises DNS_time_ms (DNS time in milliseconds), TCP_time_ms (TCP time in milliseconds), TLS_time_ms (TLS time in milliseconds), TTFB_time_ms (TTFB time in milliseconds), total_time_ms (total time in milliseconds) and data_size;
wherein Latency_time_ms comprises the difference between the TTFB_time_ms and TLS_time_ms;
wherein Effective_data_rate_kbps comprises the data_size divided by the difference between total_time_ms and tls_time_ms expressed as kilobits per second;
wherein Wgt_DNS is a weight to be assigned to DNS time, Wgt_TCP is a weight to be assigned to TCP time, Wgt_TLS is a weight to be assigned to effective latency, Wgt_DR is a weight to be assigned to effective data range, Alpha_DNS is a threshold DNS time below which DNS_time_ms is irrelevant, Alpha_TCP is a threshold TCP time below which TCP_time_ms is irrelevant, Alpha_TLS is a threshold TLS time below which TLS_time_ms is irrelevant, Alpha_DR is a threshold data rate above which Effective_data_rate_kbps is irrelevant, Beta_DNS is a factor for the rate at which DNS_time_ms above Alpha DNS affects the QOE Score, Beta_TCP is a factor for the rate at which TCP_time_ms above Alpha_TCP affects the QOE Score, Beta_TLS is a factor for the rate at which TLS_time_ms above Alpha_TLS affects the QOE Score, Beta_DR is a factor for the rate at which Effective_data_rate_kbps below Alpha_DR affects the QOE Score.

20. A method for generating a quality of experience score from a curl probe statistic comprising:
$$QOE score = max ( 0 , 0.1 * ( max ( 0 , DNS\_time \_ms - 500 ) * ( - 0.0713 ) + 100 ) + 0.15 * ( max ( 0 , TCP\_time \_ms - 5 \; 00 ) ⋆ ( - 0.0425 ) + 100 ) + 0.25 ( max ( 0 , TLS\_time \_ms - 5 \; 00 ) ⋆ ( - 0.04 ) + 100 ) + 0.37 ⋆ ( Latency\_time \_ms ⋆ ( - 0.02 ) + 100 ) + 0.13 ⋆ ( 76 \text{.92} - 461.53 ⋆ 1.01 ⋀ ( - 0.78 ⋆ min ( Effective\_data \_rate \_kbps , 500 ) )$$
wherein the curl probe statistic comprises DNS_time_ms (DNS time in milliseconds), TCP_time_ms (TCP time in milliseconds), TLS_time_ms (TLS time in milliseconds), TTFB_time_ms (TTFB time in milliseconds), total_time_ms (total time in milliseconds) and data_size;
wherein Latency_time_ms comprises the difference between the TTFB_time_ms and TLS_time_ms; and
wherein Effective_data_rate_kbps comprises the data_size divided by the difference between total_time_ms and tls_time_ms expressed as kilobits per second.
